(19) United States
(12) Patent Application Publication
(10) Pub. No.: US 2005/0064904 A1
(43) Pub. Date: Mar. 24, 2005

(54) Mobile communication terminal for providing UV information and method for providing UV information using the same

(75) Inventors: Jang-Woo Ryu, Suwon-si (KR); Jung-Woo Suh, Seoul (KR); Kyung-Sup Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/943,333

(22) Filed: Sep. 17, 2004

(30) Foreign Application Priority Data
Sep. 22, 2003 (KR) 65591/2003
Aug. 30, 2004 (KR) 68386/2004

(51) Int. Cl. H04M 1/00

(52) U.S. Cl. 455/556.1; 379/106.01

(57) ABSTRACT

A mobile communication terminal is provided with a UV sensor for sensing UV rays and generates an electric signal in proportion to the amount of sensed UV rays. The terminal includes a memory for storing UV information according to a UV index, and a control unit for detecting a UV index from the electric signal from the UV sensor and reading UV information in response to the detected UV index to inform a user.

### PRIORITY

This application claims priority to applications entitled “Mobile Communication Terminal For Providing UV Information And Method For Providing UV Information Using The Same” filed with the Korean Intellectual Property Office on Sep. 22, 2003 and assigned Serial No. 2003-65591, and filed on Aug. 30, 2004 and assigned Serial No. 2004-68386, the contents of each of which are hereby incorporated by reference.

### BACKGROUND OF THE INVENTION

1. Field of the Invention

The present invention relates to a mobile communication terminal, and more particularly to a mobile communication terminal capable of detecting UV rays.

2. Description of the Related Art

Current acceleration of environment pollution, mainly due to industrialization and the increased amount of automobiles in operation has led to the deterioration of the ozone layer in the upper stratosphere and the increase of UV (ultraviolet) rays from the sun reaching the ground.

Excessive exposure to UV rays from the sun has an overall negative influence on the ecosystem and human health resulting in such illnesses as skin cancer, degrading of the immune system, retarded growth of domestic animals, crop reduction and drastic change in the underwater ecosystem having an effect on many species of fish, including planktons. The influence of UV rays on the human body has been studied to a considerable degree. Well known effects of UV radiation on human skin include erythema and pigment response. Exposure to solar radiation injures skin tissue. In particular, excessive exposure to UV rays for an extended period increases the potential for skin cancer. UV rays can even damage the human eyes and increases the possibility of cataract formation. When reaching the retina, UV rays gradually destroys the retinal cells and, as time elapses, eyesight deteriorates.

The meteorological industry has developed a UV index prediction model, based on the change of weather and amount of ozone in the stratosphere. The UV index is used to forecast the expected danger during excessive exposure to the sun and to inform people, who engage in outdoor activities, of how much care they must take.

The UV index refers to the amount of radiation in the UV-B region, converted into an exponential equation, which reaches the ground when the sun crosses the meridian. The UV index has ten grades: grade 0 means that it is hardly dangerous even with excessive exposure, while grade 9 means that it is very dangerous with excessive exposure.

However, UV index information is provided only once a day. This makes it difficult to be adequately informed on the UV index as the weather changes and to provide against UV rays accordingly. In an attempt to solve this problem, a UV sensing apparatus has been developed to provide for detecting the UV index. The UV sensing apparatus warns a user by a buzzing sound when the UV index exceeds a preset critical value, which corresponds to a dangerous level with excessive exposure. However, the UV sensing apparatus cannot inform the user of the exact UV index, and the user is warned only after he has been exposed to UV rays to a dangerous degree. In addition, the user must separately purchase and carry the UV sensing apparatus, which can be inconvenient to the user.

### SUMMARY OF THE INVENTION

Accordingly, the present invention has been made to solve the above-mentioned problems occurring in the prior art and an object of the present invention is to provide a method for detecting a UV index with a mobile communication terminal to provide a user with the index and a mobile communication terminal for using that method.

In order to accomplish this object, there is provided a mobile communication terminal which includes a UV sensor for sensing UV rays and generating an electric signal in proportion to the amount of sensed UV rays; a memory for storing UV information according to a UV index; and a control unit for detecting a UV index from the electric signal from the UV sensor and reading UV information in response to the detected UV index to inform a user.

In accordance with another aspect of the present invention, there is provided a mobile communication terminal which comprises a UV sensor for sensing UV rays and generating an electric signal in proportion to the amount of sensed UV rays; a memory for storing UV information according to a UV index; and a control unit for detecting a UV index from the electric signal from the UV sensor and reading UV information in response to the detected UV index to inform a user and to simultaneously transmit the UV information to another mobile communication terminal via an SMS (Short Message Service) message.

In accordance with another aspect of the present invention, there is provided a method for providing UV information using a mobile communication terminal including sensing UV rays and generating an electric signal in proportion to the amount of sensed UV rays; detecting a UV index from the electric signal; and informing a user of UV information in response to the detected UV index.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the construction of a mobile communication terminal according to the present invention;

FIG. 2 is a flow chart showing the operation of a mobile communication terminal, when providing UV index information, according to a first embodiment of the present invention;

FIG. 3 is a flow chart showing the operation of a mobile communication terminal, when providing UV index information, according to a second embodiment of the present invention;

FIG. 4 shows an example of UV index information stored in a memory of a mobile communication terminal according to the present invention;

FIG. 5 shows a screen for setting a UV detection mode according to the present invention;

FIG. 6 shows a screen for displaying UV information according to the present invention;

FIG. 7 is a flow chart showing the operation of a mobile communication terminal, when providing UV index information, according to a third embodiment of the present invention;

FIG. 8 shows screens for transmitting UV index information to another mobile communication terminal according to an embodiment of the present invention; and

FIG. 9 is a flow chart showing the operation of a mobile communication terminal, when providing UV index information, according to a fourth embodiment of the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

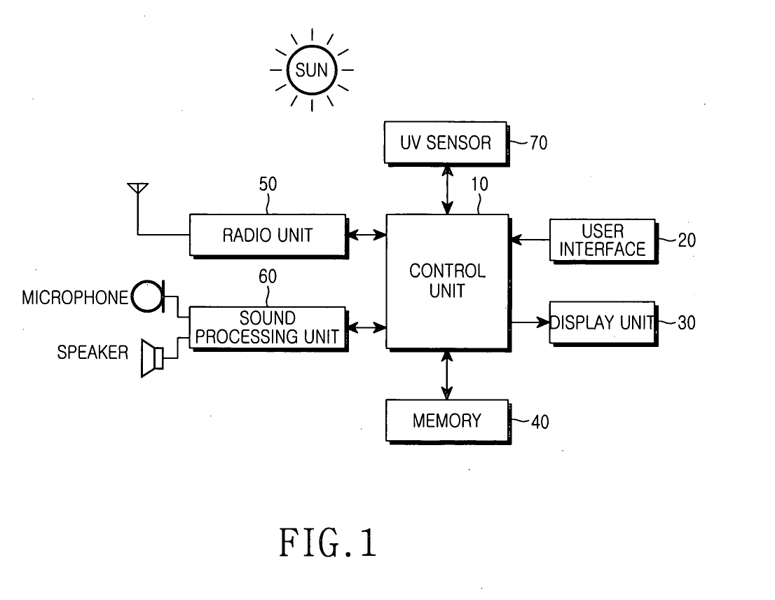

Referring to FIG. 1, the mobile communication terminal of the present invention includes a control unit 10, a user interface 20, a display unit 30, a memory 40, a radio unit 50, a sound processing unit 60, and a UV sensor 70. The control unit 10 has overall control of the mobile communication terminal. The control unit 10 activates the UV sensor 70 and detects a UV index in response to a UV detection signal from the UV sensor 70. When activated, the UV sensor 70 senses UV rays from the sun, generates an electric signal in proportion to the amount of detected UV rays and provides the signal to the control unit 10. The UV sensor 70 is preferably positioned on the exterior of the mobile communication terminal so that it can easily receive UV rays from the sun, or may be located in a position that can be exposed to the exterior when the user desires. The control unit 10 reads information from the memory 40 in response to the detected UV index and displays the information on the display unit 30. The memory 40 stores UV index information according to the UV index. In particular, the memory 40 stores illustrative information regarding how a user should react to UV exposure according to the UV index, which is indicated by a value of 1 to 10. Although the user may be informed of the UV index in a UV detection mode, the user does not know how much influence a specific UV index value has on his body. Therefore, the mobile communication terminal according to the present invention provides recommendations based on the UV index, as well as the UV index itself. Such information can be stored in the memory 40 according to the UV index.

The control unit 10 can also provide another mobile communication terminal with UV index information through, e.g., an SMS message. For example, concurrently with providing the user with UV information, the control unit 10 can transmit the UV information to another user's mobile communication terminal using an inputted telephone number. Alternatively, when transmitting an SMS message to another user's mobile communication terminal, the control unit 10 can add UV index information to the SMS message.

The user interface 20 has a number of numerical and function keys and is adapted to output data, which is inputted by the user with the keys, to the control unit 10. The user interface 20 may be composed of a conventional key matrix or a touch screen. When the user interface 20 is made up of a touch screen, an input means including a stylus pen may be used to choose or input a number of numerical, function and arrow keys displayed on the touch screen. The display unit 30 displays various messages under the control of the control unit 10. The display unit 30 may be composed of an LCD (Liquid Crystal Display), a TFT (Thin Film Transistor), or an organic EL (electroluminescence). The radio unit 50 controls the transmission and reception of sound, character and control data under the control of the control unit 10. The sound processing unit 60 converts the sound data, which is received by the radio unit 50, into an audible sound and outputs it through a speaker under the control of the control unit 10. It then converts the user's voice into an electric signal which is provided to the control unit 10.

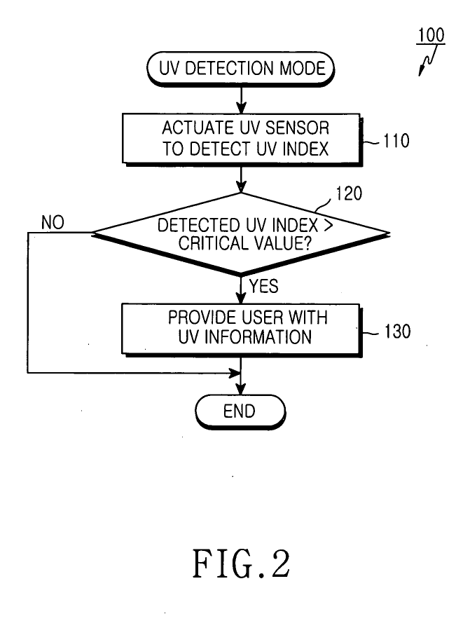

FIG. 2 is a flow chart 100 showing the operation of a mobile communication terminal, when providing UV index information, according to a first embodiment of the present invention.

Referring to FIGS. 1 and 2, the control unit 10 activates the UV sensor 70 in a UV detection mode to detect the UV index in step 110. When activated, the UV sensor 70 senses UV rays, generates an electric signal in proportion to the amount of detected UV rays and provides the signal to the control unit 10. The control unit 10 detects the UV index from the electric signal from the UV sensor 70. The control unit 10 then proceeds to step 120 and decides whether the detected UV index is larger than a predetermined critical value or not, which may be set by the user. The user can preset a specific value of the UV index so that he can be warned when the UV index reaches that value. If the detected UV index is larger than the predetermined critical value, the control unit 10 informs the user of the UV information in step 130. Preferably, the control unit 10 causes the display unit 30 to display a warning message, and may also output a warning sound to the user through the sound processing unit 60. Alternatively, the control unit 10 may control the display unit 30 and the sound processing unit 60 to provide the user with the warning message and sound simultaneously.

The warning mode can be preset by the user. One or both of the warning message and the warning sound can be outputted according to the user's presetting. Alternatively, a vibration mode may be adopted as the warning mode. Such a warning mode can be chosen by the manufacturer or the user.

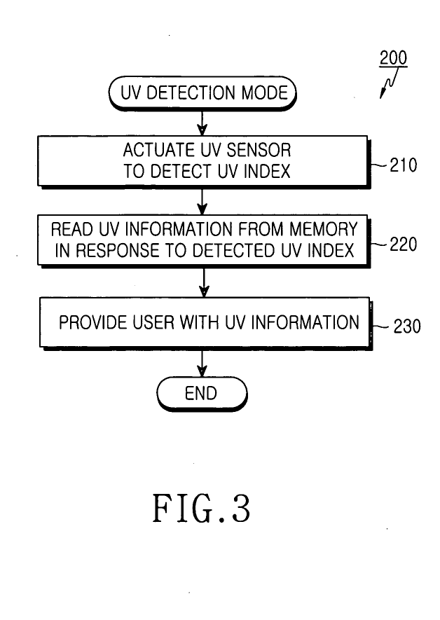

FIG. 3 is a flow chart 200 showing the operation of a mobile communication terminal, when providing UV index information, according to a second embodiment of the present invention.

Referring to FIGS. 1 and 3, a user can select a UV detection mode in a menu of the mobile communication terminal when he wants to know the UV index. If the UV detection mode is chosen, the control unit 10 activated the UV sensor 70 in step 210 to detect the UV index. When activates, the UV sensor 70 senses UV rays, generates an electric signal in proportion to the amount of detected UV rays and provides the signal to the control unit 10. The control unit 10 detects the UV index from the electrical signal from the UV sensor 70. The control unit 10 then proceeds to step 220, reads UV information from the memory 40 in response to the detected UV index and provides the UV information by displaying the information on the display unit 30 at step 230. The control unit 10 may also output a warning sound to the user through the sound processing unit 60 as mentioned above. If the UV index is below a predetermined critical value, the warning sound may be a melody. For example, the melody may be used to inform the user, when the UV index is not at a dangerous level, of the fact that UV information is displayed on the display unit 30 according to the UV index.

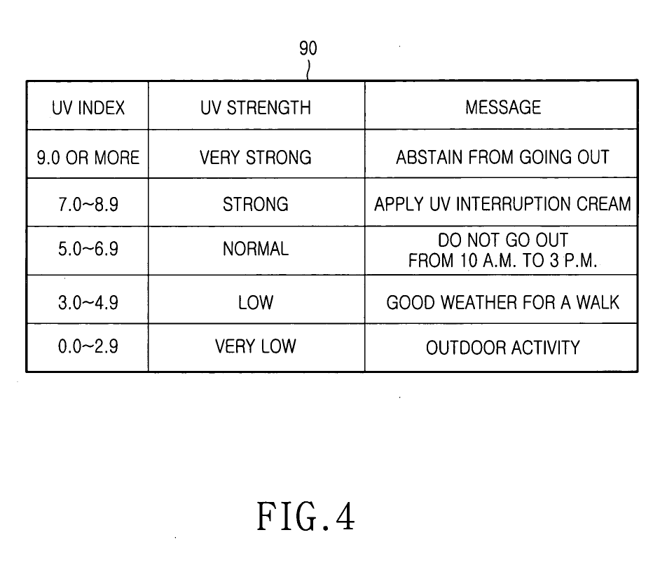

The memory 40 stores information on the strength of UV rays and recommendations according to the UV index, as mentioned above. FIG. 4 shows an example of UV index information stored in the memory 40 of the mobile communication terminal according to the present invention. The memory 40 stores values of the UV index and corresponding information in tabular form as shown in FIG. 4. However, this is not limited in the present invention. Referring to FIG. 4, the memory 40 stores information on the strength of UV rays and corresponding recommendations according to the detected UV index. For example, if the UV index is 6.2, the control unit 10 displays corresponding information that the UV strength is normal and a corresponding recommendation “Do not go out from 10 A.M. to 3 P.M.” on the display unit 30 from the memory 40.

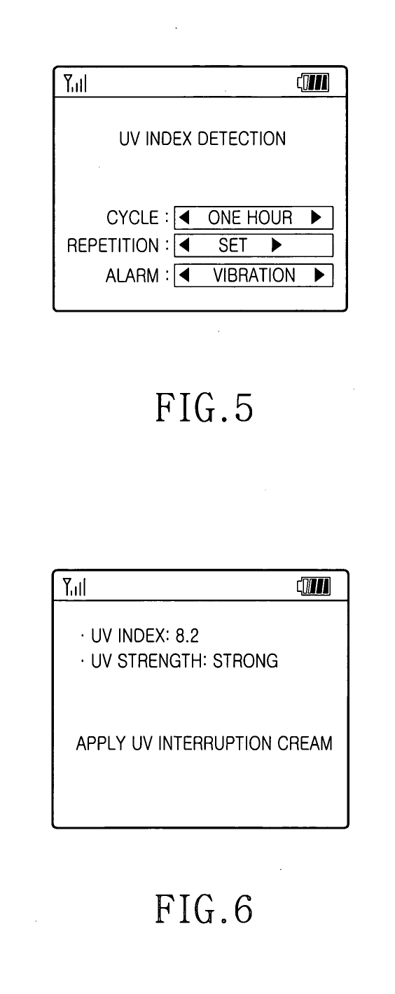

FIG. 5 shows a screen for setting a UV detection mode according to an embodiment of the present invention and FIG. 6 shows a screen for displaying UV information according to an embodiment of the present invention.

Referring to FIG. 5, the UV index detection mode can be performed periodically according to the user's setting. In the screen shown in FIG. 5, the “cycle” portion of the UV index detection mode is used to set how frequently the UV index detection is to be performed. The cycle a user can select includes once, hourly and daily. For example, if “one hour” is set for the cycle, the control unit 10 performs the UV index detection mode every hour. The “repetition” selection portion is used to determine whether the UV index detection is to be performed according to the preset cycle or not. The choice for the repetition includes “set” and “cancel”. For example, if the repetition of the UV index detection is set as “cancel”, the control unit 10 does not enter the UV index detection mode periodically even when the cycle of the UV index detection mode is chosen. The “alarm” portion of the UV index detection is used to choose the means for warning the user, when providing information regarding the detected UV index. For example, the choice for the alarm includes vibration, a sound, a message and a combination thereof. If vibration and a message are chosen by the user, the control unit 10 provides the user with information, after detecting the UV index, using both vibration and a message according to the setting. The control unit 10 detects the UV index, as set by the user, and provides UV information according to the UV index, as shown in FIG. 6.

According to the first and second embodiments of the present invention, as mentioned above, the mobile communication terminal has a UV sensor 70 so that a user can detect the UV index with his own mobile communication terminal and to easily cope with UV rays according to the UV index.

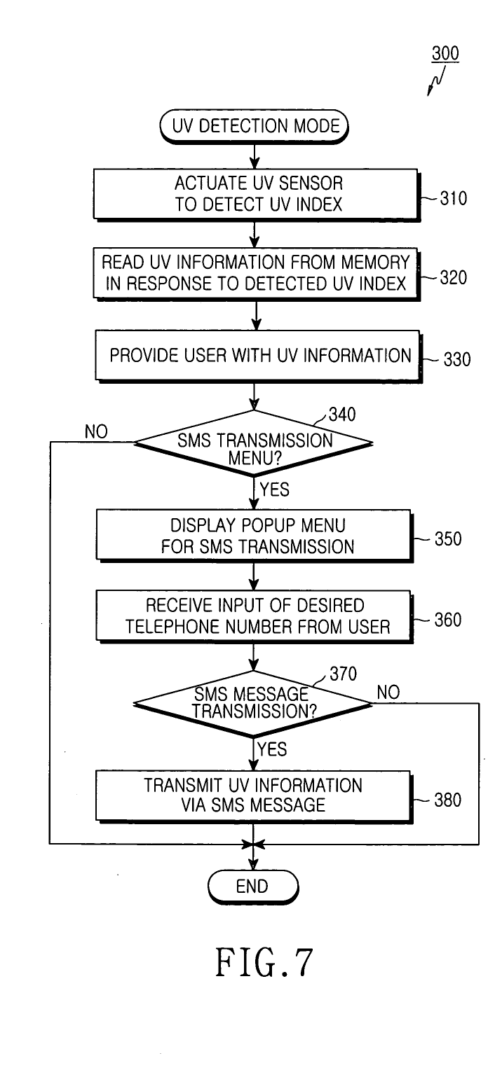

Meanwhile, a user of a mobile communication terminal, which has no UV sensor and is not able to detect the UV index, cannot easily obtain information on the UV index. In order to solve this problem, the mobile communication terminal according to the present invention is adapted to provide another mobile communication terminal with UV index information via, e.g., an SMS message. Such an embodiment of the present invention for transmitting UV index information via an SMS message will now be described with reference to FIGS. 7 to 9.

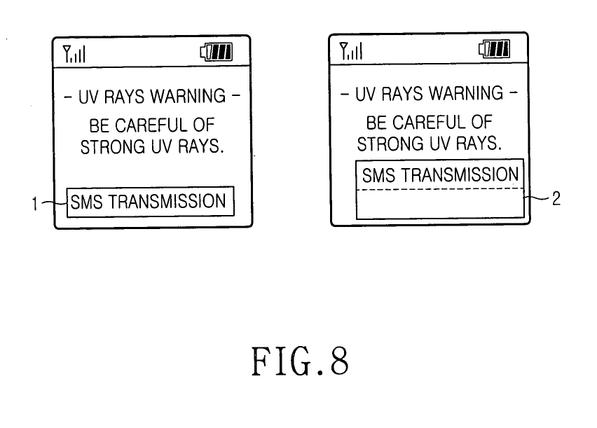

FIG. 7 is a flow chart 300 showing the operation of a mobile communication terminal, when providing UV index information, according to a third embodiment of the present invention and FIG. 8 shows screens for transmitting UV index information to another mobile communication terminal according to an embodiment of the present invention.

Referring to FIG. 7, the control unit 10 activates the UV sensor 70 to detect the UV index in step 310, if a user chooses a UV detection mode. Particularly, the UV sensor 70 generates an electric signal in proportion to a sensed amount of detected UV rays, when activated. The control unit 10 then detects the UV index from the electric signal from the UV sensor 70. The control unit 10 reads UV index information from the memory 40 in response to the detected UV index in step 320 and informs the user of the information in step 330. The UV index information is displayed on the screen of the display unit 30 as shown in FIG. 8A, together with an SMS transmission menu box 1 so that the UV index information, which is provided to the user, can also be easily transmitted to another person. As such, the control unit 10 provides an SMS transmission menu so that the user can transmit the UV index information to another person, concurrently with providing the user with the UV index information in step 330.

The control unit 10 then decides whether the user has chosen to transmit an SMS of the UV information in step 340. When the control unit 10 displays an SMS transmission menu 1 on the screen of the display unit 30, as shown in FIG. 8A, the user can select the SMS transmission menu box 1.

If the SMS transmission menu is chosen by the user, the control unit 10 displays a popup window 2 for SMS transmission, as shown in FIG. 8B, on the screen of the display unit 30 in step 350. The popup window 2 is used to input the telephone number of another mobile communication terminal to which the UV information is to be transmitted. The control unit 10 receives the input of a telephone number from the user for use in UV information transmission in step 360.

The control unit 10 decides whether the user chooses to transmit an SMS message containing UV information in step 370. For example, the user can choose to transmit an SMS message by pressing a key for SMS message transmission. If the user chooses to transmit an SMS message, the control unit 10 transmits an SMS message containing UV index information to a desired mobile communication terminal in step 380.

The third embodiment of the present invention, as mentioned above, makes it possible for a user to transmit UV index information, which is provided by his own mobile communication terminal, to another mobile communication terminal via an SMS message. A fourth embodiment of the present invention makes it possible to add UV index information to an SMS message, which is composed by a user with his mobile communication terminal, in a manner similar to that of the third embodiment.

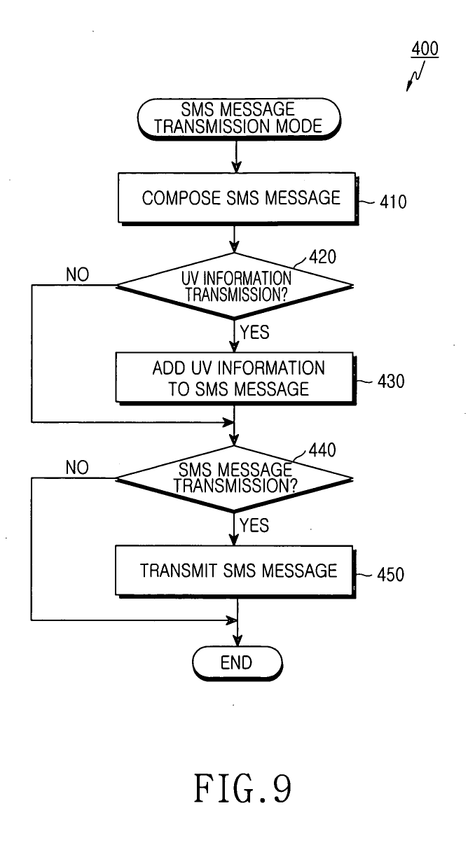

FIG. 9 is a flow chart 400 showing the operation of a mobile communication terminal, when providing UV index information, according to a fourth embodiment of the present invention.

Referring to FIG. 9, the control unit 10 receives input of an SMS message from a user in step 410 and decides whether the user chooses transmit UV information in step 420. The control unit 10 can display a UV information transmission box on an SMS message input window, which is similar to the SMS transmission menu box 1 shown in FIG. 8A, so that the user can choose a UV information transmission menu. If the user chooses the UV information transmission, the control unit 10 proceeds to step 430 and adds the UV information to an SMS message which is composed by the user or to any other SMS message. The UV information is based on the last measurement of the UV index. The control unit 10 then decides whether the user chooses to transmit an SMS message containing the UV information in step 440. If the user chooses SMS message transmission, the control unit 10 transmits the UV index information to a desired mobile communication terminal, together with the SMS message of the user, in step 450.

As mentioned above, a mobile communication terminal is equipped with a UV sensor and provides information on the UV index according to the present invention so that a user can be easily informed of the constantly changing UV index. In addition, the present invention makes it possible to provide another mobile communication terminal, which has no UV sensor, with UV index information through, e.g., an SMS message.

While the invention has been shown and described with reference to certain preferred embodiments thereof, it will be understood by those skilled in the art that various changes in form and details may be made therein without departing from the spirit and scope of the invention as defined by the appended claims.

1. A mobile communication terminal comprising:
a UV sensor for sensing UV rays and generating an electric signal in proportion to the amount of sensed UV rays;
a memory for storing UV information according to a UV index; and
a control unit for detecting a UV index from the electric signal from the UV sensor and reading UV information in response to the detected UV index to inform a user.

2. A mobile communication terminal as claimed in claim 1, wherein the stored UV information includes at least one of UV strength and corresponding recommendations.

3. A mobile communication terminal as claimed in claim 1, wherein the control unit outputs any one of vibration, a sound, a message, and a combination thereof to inform the user of the UV information.

4. A mobile communication terminal as claimed in claim 1, wherein the control unit compares the detected UV index with a predetermined critical value and, when the detected UV index is larger than the critical value, warns the user.

5. A mobile communication terminal as claimed in claim 1, wherein the control unit periodically detects the UV index, when it is set to periodically perform UV index detection by the user, and informs the user of the UV information.

6. A method for providing UV information using a mobile communication terminal comprising the steps of:
sensing UV rays and generating an electric signal in proportion to the amount of sensed UV rays;
detecting an UV index from the electric signal; and
informing a user of UV information in response to the detected UV index.

7. A method for providing UV information as claimed in claim 6, wherein the user is informed of the UV information by any one of vibration, a sound, a message, and a combination thereof.

8. A method for providing UV information as claimed in claim 6, wherein the UV information includes at least one of UV strength and corresponding recommendations.

9. A mobile communication terminal comprising:
a UV sensor for sensing UV rays and generating an electric signal in proportion to the amount of sensed UV rays;
a memory for storing UV information according to a UV index; and
a control unit for detecting a UV index from the electric signal from the UV sensor and reading UV information in response to the detected UV index to inform a user and to simultaneously transmit the UV information to another mobile communication terminal via an SMS message.

10. A mobile communication terminal as claimed in claim 9, wherein the UV information includes at least one of UV strength and corresponding recommendations.

11. A mobile communication terminal as claimed in claim 9, wherein the control unit provides a menu for SMS transmission, when informing the user of the UV information, and receives an input of a telephone number of another mobile communication terminal from the user, if the user chooses SMS transmission of the UV information.

12. A method for providing UV information using a mobile communication terminal comprising the steps of:
sensing UV rays and generating an electric signal in proportion to the amount of sensed UV rays;
detecting an UV index from the electric signal;
informing a user of UV information in response to the detected UV index; and
transmitting the UV information to another mobile communication terminal via an SMS message.

13. A method for providing UV information as claimed in claim 12, further comprising the steps of:
providing a menu for SMS transmission of the UV information when informing the user of the UV information; and
receiving an input of a telephone number of another mobile communication terminal from the user, if the user chooses SMS transmission of the UV information.

14. A mobile communication terminal comprising:
a UV sensor for sensing UV rays and generating an electric signal in proportion to the amount of sensed UV rays;
a memory for storing UV information according to a UV index; and
a control unit for detecting a UV index from the electric signal from the UV sensor, reading UV information in response to the detected UV index, and storing the UV information, the control unit being adapted to add the UV information to an SMS message composed by the user and to transmit the UV information with the SMS message, if the user chooses transmission of the UV information when composing the SMS message.

15. A method for providing UV information using a mobile communication terminal comprising the steps of:
sensing UV rays and generating an electric signal in proportion to the amount of sensed UV rays;
detecting an UV index from the electric signal;
reading and storing UV information in response to the detected UV index;
deciding whether a user chooses transmission of the UV information when composing an SMS message; and
adding the UV information to the SMS message composed by the user and transmitting the UV information with the SMS message, if the user chooses transmission of the UV information.
